(19) United States
(12) Patent Application Publication
(10) Pub. No.: US 2002/0191334 A1
(43) Pub. Date: Dec. 19, 2002

(54) Magnetic transducer with pedestal pole piece structure

(76) Inventors: Yimin Hsu, Sunnyvale, CA (US); Hugo Alberto Emilio Santini, San Jose, CA (US); Neil Smith, San Jose, CA (US); Mason Lamar Williams, San Jose, CA (US)

Correspondence Address: Marlin Knight, Hoyt & Knight, PO Box 1320, Pioneer, CA, 95666, US

(21) Appl. No.: 09/884,607

(22) Filed: Jun. 18, 2001

(51) Int. Cl. G11B 5/17

(52) U.S. Cl. 360/123

(57) ABSTRACT

A magnetic transducer with a write head with one or more coil layers and a pedestal pole piece on P1 is disclosed. In one embodiment the first and second coils and the P1 pedestal are formed on essentially planarized surfaces which allows maximum precision to be obtained from the photolithography. The P1 pedestal defines the zero throat height (ZTH) with a 90 degree apex angle which cuts down flux leakage and improves efficiency. The P1 pedestal allows the coil turns to be located close to the write gap to increase the magnetic efficiency. The P1 pedestal also acts as a domain control element. The first and second coils are disposed on opposite sides of the gap layer. The write head preferably has upper and lower back flux closure pieces in contact with the pole pieces to complete the back of the yoke. Various combinations of these features allow heads according to the invention to be made with a very short yoke with resulting improved efficiency. In alternative embodiments the coil below the gap layer may be omitted and/or an additional coil above the gap layer may be added.

### RELATED APPLICATIONS

Pending U.S. patent application bearing Ser. No. 09/154,527, commonly assigned with the present application, describes a head with laminated pole pieces with a P1 pedestal domain control element and is hereby incorporated into this application by reference.

### FIELD OF THE INVENTION

The invention relates to the field of magnetic transducers (heads) having inductive write heads and more particularly to the structure of and the process for making the pole pieces and coil for the write head.

### BACKGROUND OF THE INVENTION

A typical prior art disk system is illustrated in FIG. 1. In operation the magnetic transducer 10, usually called a “head,” is attached to an arm or actuator 13 and flies above the rotating disk 16. A voice coil motor 19 (VCM) pivots the actuator 13 to position the magnetic transducer 10 over selected circumferential tracks on the disk 16. The disk 16 is attached to spindle 18 that is rotated by a spindle motor (not shown). The disk 16 comprises a substrate on which a plurality of thin films are deposited. The thin films include ferromagnetic material that is used to record the magnetic transitions written by the magnetic transducer 10 in which information is encoded. A tape based storage system uses a magnetic transducer in essentially the same way as a disk drive, with the moving tape being used in place of the rotating disk 16.

The magnetic transducer 10 is composed of elements that perform the task of writing magnetic transitions (the write head 23) and reading the magnetic transitions (the read head 12) as illustrated in FIG. 2. The electrical signals to and from the read and write heads 12, 23 travel along conductive paths (leads) (not shown) which are attached to or embedded in the actuator 13. Typically there are two leads each for the read and write heads 12, 23.

FIG. 2A is a midline section of one type of prior art magnetic transducer 10A. The components of the read head 12 are the first shield (S1), two insulation layers 107, 109 which surround the sensor element 105 and the second shield 104 (P1/S2). This type of magnetic transducer 10A is called a “merged head” because the P1/S2 layer 104 serves as a shield for the read head 12 and a pole piece for the write head 23A. The yoke also includes a second pole piece 103 (P2) which connects with P1/S2 104 at the “back gap” (BG). The term “back gap” it should be noted is used in the art to mean the back of the yoke. Historically there was a gap in the back of the yoke and the term “back gap” continues to be used even though the back of the yoke is now continuous. The P₂ 103 confronts the P₁ 104 across the write gap layer 42 to form the write gap 43 at the air bearing surface (ABS). The coil 37 in this particular prior art head is deposited on a layer of resist 106 which is used to define the zero throat height (ZTH) by forming a step on the gap layer 42. The imprecision inherent in creating the step in resist material, alumina, etc., make it difficult to reduce the distance between the ZTH and the ABS. This is one of the limitations encountered when attempts are made to reduce the track width of this type of head 10.

FIG. 2B is a midline section of a second type of prior art magnetic transducer 10B. There are two significant differences between the magnetic transducers 10A and 10B in FIGS. 2A and 2B. One difference is that the yoke in magnetic transducer 10B has three pole pieces P₁ 104, P₂ 103A and P₃ 103B. The P₂ 103A is formed at the write gap 43 a separate element. The third pole piece 1031B (P3) is stitched to P₂ 103A and is connected to the P₁ 104 at the back gap (BG) to complete the yoke. Typically write heads 23 only have one coil layer 37, but the particular write head 23B shown has two coil layers which be called coil1 37 and coil2 57. The turns of both coil1 and coil2 are routed between the write gap 43 and the back gap (BG) and then around behind the yoke. The P3 103B arches over the resist mound 111 which surrounds the coil(s). In either of the prior art write heads 23A, 23B the angle at which the bottom surface of P2 moves away from the ZTH point is typically far less than 90 degrees which results in efficiency losses through flux leakage.

As the required recording densities increase the width of the written track must decrease. For example, 40 Gb/in² requires an effective pole tip size of 0.35 microns. However, the coercivity of the ferromagnetic thin films on the disk must increase and the recording speed must increase. The needed write head must have high magnetic efficiency and low inductance. These requirements make it necessary to place the inductive components closer to the pole tips than is possible using the prior art.

### SUMMARY OF THE INVENTION

Applicant discloses a magnetic transducer with a write head with a pedestal pole piece on P1 and a planarized gap layer with single and multilayer coil embodiments and planarized P3 embodiments. The P1 pedestal and at least one coil are formed on essentially planarized surfaces which allows maximum precision to be obtained from the photolithography. The P1 pedestal defines the zero throat height (ZTH) with a 90 degree apex angle which cuts down flux leakage and improves efficiency. The P1 pedestal allows the distance from the ZTH to the ABS to be reduced which allows the coil turns to be located closer to the write gap to increase the magnetic efficiency. In one family of embodiments the first and second coils are disposed on opposite sides of the gap layer. The yoke of the write head preferably has upper and lower flux closure pieces at the back which facilitate in making P1 and P3 planar. Various combinations of these features allow heads according to the invention to be made with a very short yoke with resulting improved efficiency. In addition the head may be made with a physical P2 tip size under one micron and an effective P2 size which is comparably small.

In a preferred embodiment of a process for fabricating a head according to the invention, the P1 layer is planarized to allow increased precision in the formation of the P1 pedestal and the first coil. A thin layer of dielectric material is deposited over the planarized P1 surface to provide a surface for formation of the coil. The first coil is then formed using prior art techniques, but because the surface is well planarized, the pitch of the coil can be made very small. In the next phase in this embodiment the P1 pedestal and the lower back flux closure at the back of the yoke are formed on the planarized P1. In another embodiment the first coil is formed before the P1 pedestal and lower back flux closure. In each of these embodiments the wafer is planarized after a thick layer of dielectric material is deposited over the first coil and the P1 pedestal and lower back flux closure. This is an advantage of the invention, since the gap layer is then formed on a planarized surface and in turn provides a planar surface for the precise formation of the P2 tip and the second coil. After the gap layer is deposited, it is etched away over the lower back flux closure. At this point the ferromagnetic material for the P2 pole piece and the upper back flux closure is deposited. The P2 pole piece confronts the P1 pedestal across the gap layer to form the write gap. The upper back flux closure contacts the lower back flux closure to form the back of the yoke structure in the back gap. The second coil is fabricated on the gap layer and then covered with protective material. The wafer at this point can optionally be planarized to improve the surface for the subsequent deposition of P3. The P3 in this embodiment extends from at least the stitch area of P2 over the second coil and onto the upper back flux closure completing the yoke. If the optional planarization step has been performed, then the P3 will be completely planar. The P3 may also be laminated. The P3 may extend over the P2 pole piece to the ABS or it may extend only over a rear stitch portion of the P2. Optionally a third coil may be stacked above the second coil. In this case, the P3 arches up from the P2 pole piece over the third coil and then down to contact the upper back flux closure.

Embodiments according to the invention will also be described in which the coil below the gap layer is omitted.

### BRIEF DESCRIPTION OF THE DRAWINGS

FIG. 1 is an illustration of a prior art disk drive in which the head of the invention can be embodied, showing the relationships between the head and associated components.

FIG. 2A is a section, perpendicular to the air bearing surface, of a prior art transducer with two coil layers. FIG. 2B is a section, perpendicular to the air bearing surface, of a prior art transducer with two coil layers.

FIG. 3 is a section of a transducer according to the invention, perpendicular to the air bearing surface, during fabrication after the first coil has been formed.

FIG. 4 is a section of a transducer according to the invention, perpendicular to the air bearing surface, after the P1 pedestal and lower back flux closure have been formed.

FIG. 5 is a section of a transducer according to the invention, perpendicular to the air bearing surface, after the state shown in FIG. 4, showing a layer of dielectric material deposited for planarization.

FIG. 6 is a section of a transducer according to the invention, perpendicular to the air bearing surface, subsequent to the state shown in FIG. 5, after planarization.

FIG. 7 is a section of a transducer according to the invention, perpendicular to the air bearing surface, after the state shown in FIG. 6, after the gap layer has been deposited and etched at the back to expose the lower back flux closure.

FIG. 8 is a section view of a transducer according to the invention, perpendicular to the air bearing surface, after the state shown in FIG. 7, after ferromagnetic material has been deposited to form the P2 pole piece and the upper back flux closure, and after the second coil has been formed.

FIG. 9 is a plan view of a transducer according to the invention, perpendicular to the air bearing surface, showing the relationships been the P1 pedestal (before notching), the P2 pole piece, the coils and the upper back flux closure.

FIG. 10 is a section view of a transducer according to the invention, perpendicular to the air bearing surface, subsequent to FIG. 8, after all of the components of the write head have been formed.

FIG. 11 is a section view, perpendicular to the air bearing surface, of an alternative transducer embodiment according to the invention with a planarized P3, showing all of the major components of the write head have been formed.

FIG. 12 is a section view of a transducer embodiment according to the invention, perpendicular to the air bearing surface, having three coil layers.

FIG. 13 is a section view of a partially completed transducer according to the invention, perpendicular to the air bearing surface, illustrating a second method of fabricating a head according to the invention, after the P1 pedestal and the lower back flux closure have been fabricated.

FIG. 14 is a section view of the partially completed transducer according to the invention, perpendicular to the air bearing surface, subsequent to that of FIG. 13, after the first coil has been fabricated.

FIG. 15 is a section view, perpendicular to the air bearing surface, of an alternative transducer according to the invention which has a single coil and a nonplanarized P3 which extends to the air bearing surface.

FIG. 16 is a section view, perpendicular to the air bearing surface, of an alternative transducer according to the invention which has a single coil and a planarized P3 which does not extend to the air bearing surface.

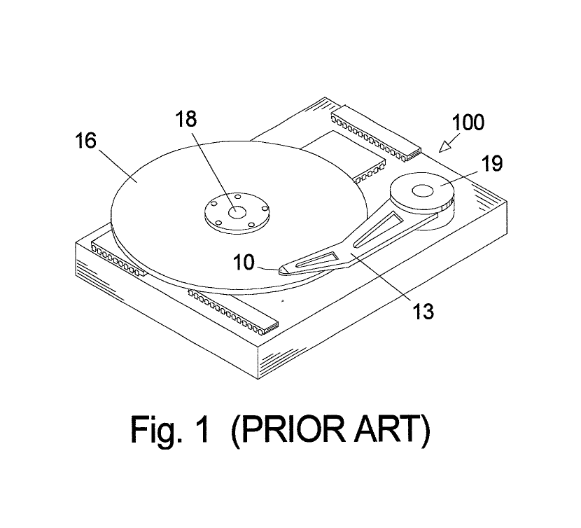

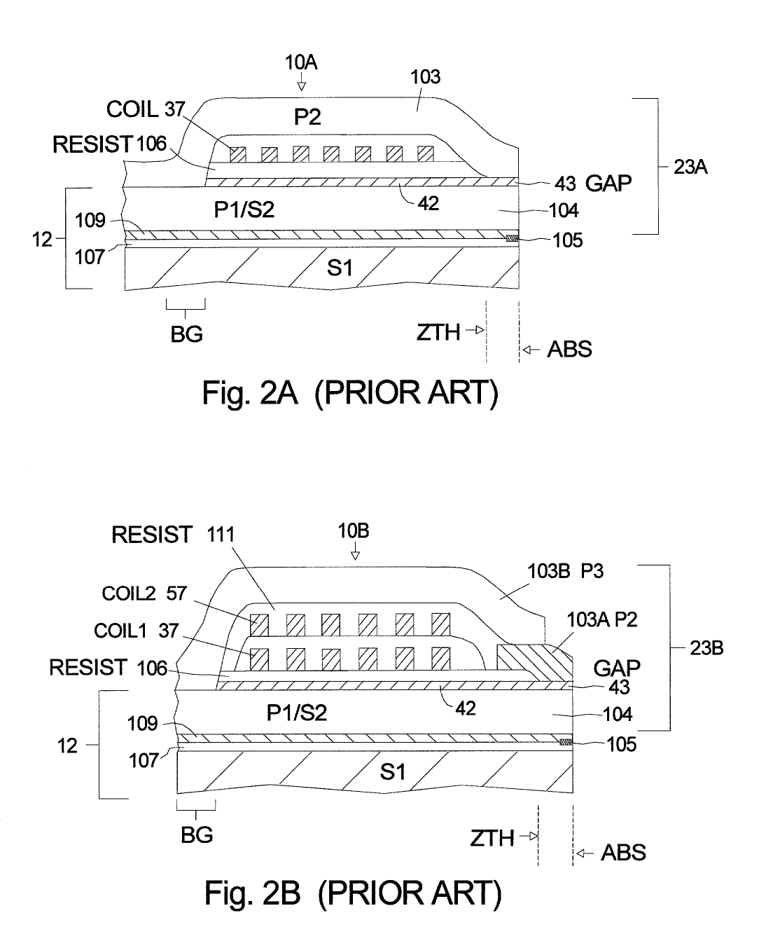

### DETAILED DESCRIPTION OF THE INVENTION AND THE PREFERRED EMBODIMENTS

It is conventional for thousands of heads to be manufactured simultaneously on a single wafer. For simplicity the following will typically describe the actions or structures for a single head, but it is to be understood that most of the process steps are performed over the entire wafer and are, therefore, forming structures for thousands of heads simultaneously. The invention relates to the write head portion of the magnetic transducer and does not place limits on the type of read head that can be used with it. Typically the read head portion of the transducer is fabricated first, but transducers with the write head portion fabricated first have been described in the prior art. A write head according to the invention may be fabricated before or after the read head portion of the transducer.

The relative sizes of the components shown in the figures are not presented according to scale, since the large range of sizes would make the drawing unclear. The relative sizes/thickness of the components are according to prior art principles except where noted below. The hatching lines are not intended to represent the material composition of a structure, but are used only to distinguish structures and aid in the explanation of the process of making the write head.

First Method of Fabricating a Write Head According to the Invention

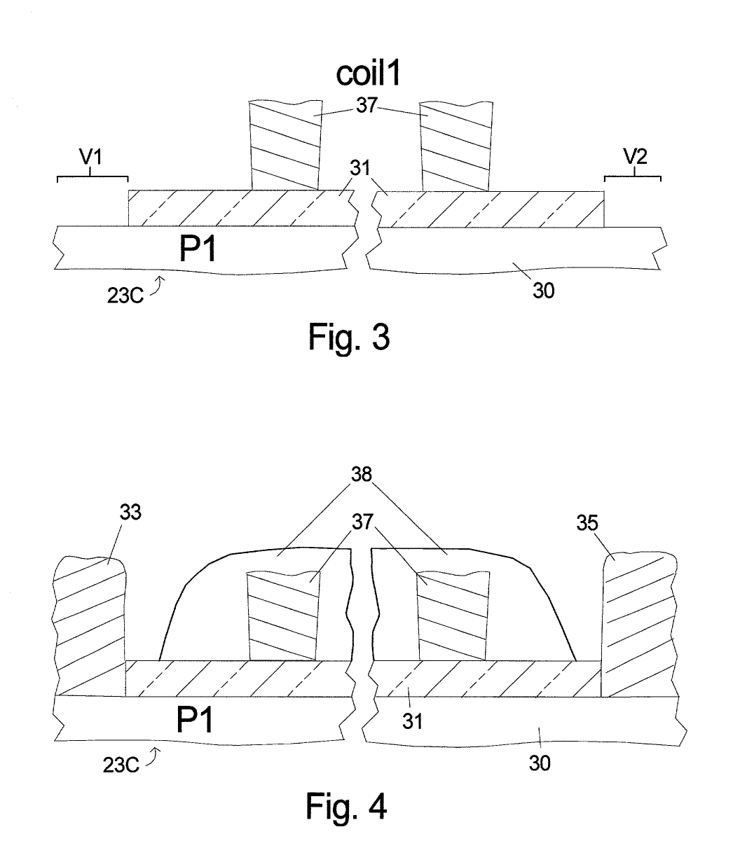

Reference is made to FIG. 3 to begin the description of the process of making a first embodiment of a write head 23C of the invention. The section view is perpendicular to the air bearing surface (ABS) (not shown) which will be on the left of the figure after the wafer is sliced. The actual ABS is delineated when the heads are cut from the wafer. The first pole piece (P1) 30 is deposited as in the prior art, on a generally planar surface and is made of standard ferromagnetic material. The P1 30 may optionally serve as a shield for the read head (not shown) if the head is a merged head. The upper surface of P1 30 is preferably planarized to establish a well controlled surface for the subsequent formation of the first coil 37 (coil1). Achieving the smallest pitch in coil1 requires that P1 be planarized. A thin layer of dielectric material such as alumina 31 is vacuum deposited over P1 30 to provide a base for coil1 37. Since the alumina 31 is vacuum deposited, it will not significantly disrupt the planarity of the surface. The thickness of the alumina layer 31 has been significantly exaggerated in this illustration in relation to the coil1 37 height. The alumina 31 only needs to be thick enough to provide the required insulating surface. The coil1 37 is fabricated using prior art techniques and materials, e.g., seed layer deposition, photolithography, copper plating, etching and seed removal. Although prior art techniques are used, the well controlled surface of the alumina 31 allows the pitch of the turns of coil1 37 to be smaller than would otherwise be possible. This is one of the advantages of the method of the invention, since a smaller coil pitch is required to improve the write head over the prior art. For similar reasons, the first turn of coil1 37 can be placed within approximately 1 pitch spacing of the P1 pedestal 33. Coil1 37 is shaped the same as prior art coils. After coil1 37 has been formed, the alumina layer 31 must be etched away to form vias V1 and V2 in which ferromagnetic material will subsequently be deposited. The turns of coi1 37 are disposed between V1 and V2, making V1 lie outside of the coil and V2 lie inside of the coil.

In FIG. 4 a subsequent point in the fabrication process is illustrated. After the vias V1 and V2 have been formed, the coil1 37 is protected and insulated preferably by photoresist material 38 which fills in between the coil turns, but is removed from the V1 and V2 areas. At this point the wafer is ready for formation of the P1 pedestal 33, which will serve as the P1 pole tip, and the lower back flux closure 35 which will connect P1 and the upper back flux closure at the back of the completed yoke (not shown). The P1 pedestal 33 and lower back flux closure 35 are preferably formed simultaneously from ferromagnetic material using prior art electroplating techniques. The P1 pedestal 33 and lower back flux closure 35 should extend at least to the height required to achieve the desired final thickness of coil1 37.

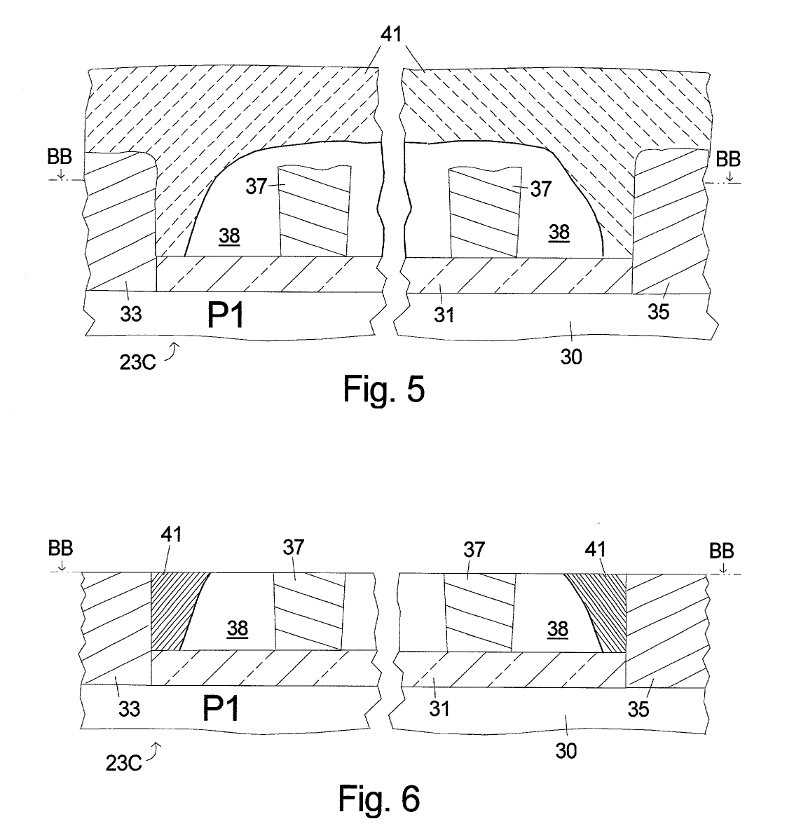

Referring to FIG. 5, a relatively thick layer of a dielectric material 41, preferably alumina, has been deposited to fill in any gaps between the insulating material 38 (photoresist) around coil1 37 and the P1 pedestal 33 and lower back flux closure 35. This layer of dielectric material 41 prepares the wafer for planarization. Photoresist may be used in place of alumina between the P1 pedestal 33 and the lower back flux closure 35. FIG. 6 illustrates the state of the fabrication after planarization, for example, by chemical-mechanical-polishing (CMP). The wafer surface material is removed to the level marked as line BB to expose and planarize the tops of the P1 pedestal 33 and lower back flux closure 35. Preferably the tops of the turns of coil1 37 are also exposed and planarized as shown. The only part of the alumina 41 which remains is that which was needed to fill the spaces described above.

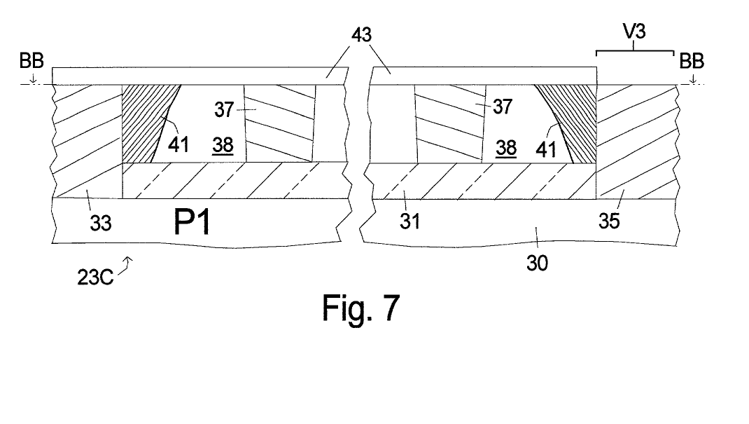

In FIG. 7 a gap layer 43 has been deposited on the planarized surface and then etched away to form a via V3 exposing the top of the lower back flux closure 35. The thickness of the gap layer 43 defines the length of the write gap. The gap layer 43 is formed from nonferromagnetic material as in the prior art, for example, alumina.

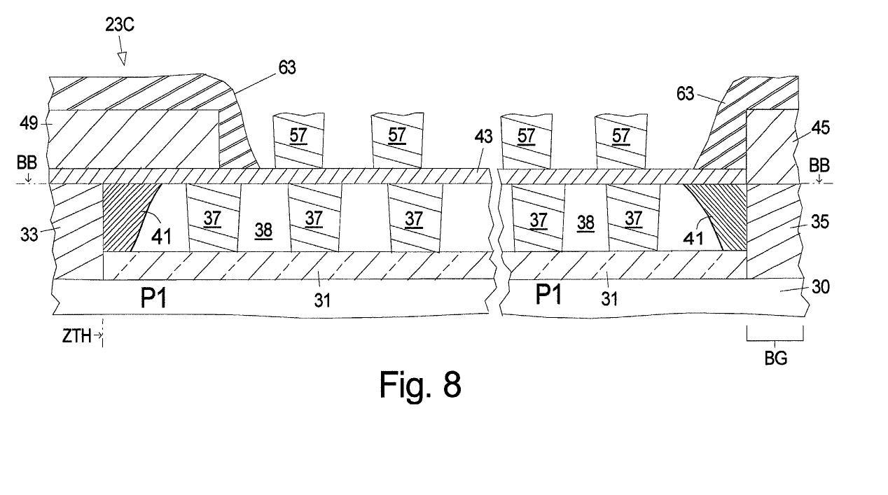

FIG. 8 shows that the upper back flux closure 45 has been formed in V3. The P2 pole piece 49 has been deposited on the gap layer 43 to confront the P1 pedestal 33 to form the write gap. The upper back flux closure 45 and P2 pole piece 49 are preferably formed simultaneously from ferromagnetic material using standard photolithography and plating. It is now clear that the back side of the P1 pedestal 33 defines the ZTH, since the planar bottom surface of P2 49 extends back farther than the P1 pedestal 33. It is also clear that the P1 pedestal 33 defines the ZTH with a 90 degree apex angle since the back of P1 pedestal 33 is perpendicular to the bottom surface of P2 pole piece 49. Having a 90 degree apex angle cuts down flux leakage, as well as, having the coil1 37 located closer to the write gap improves the efficiency of the head.

Next temporary protective material 63 such as photoresist is applied over the two ferromagnetic structures 45, 49 to protect them during fabrication of the second coil (coil2) 57. The coil2 57 is formed on the gap layer 43 which is a well planarized surface since it is vacuum deposited onto a planarized surface (BB). As was noted for coil1 37, the surface on which the coil2 57 is formed is a significant factor in the minimum coil pitch which can be obtained.

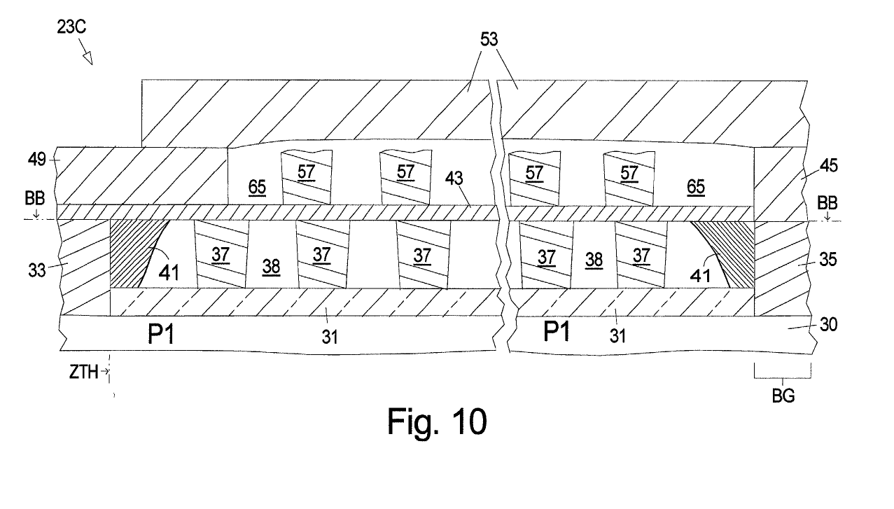

Referring to FIG. 10, after the second coil 57 is completed the temporary protective material 63 (shown in FIG. 8) is removed and a permanent protective layer 65 is formed on the second coil 57 as shown in FIG. 10. The permanent protective layer 65 can be patterned and removed from the stitch areas of the P2 pole piece 49 and the top of the upper back flux closure 45. The final ferromagnetic component, the P3 53, is deposited on the stitch area of the P2 pole piece 49, over the permanent protective layer 65, and onto the upper back flux closure 45 to complete the yoke structure. The P3 53 can be formed using standard photolithography and electroplating techniques, but vacuum deposition and patterning by ion milling could also be used.

Although the invention does not depend on particular dimensions, some comments about the relative dimensions may be instructive. For example, the thickness of the P2 pole piece 49 is preferably approximately the same as the ZTH. The ZTH in turn is typically limited by the precision with which the ABS can be formed by lapping, i.e., the lapping tolerance. The ZTH is also typically approximately 0.5 to 1.0 times the track width. An embodiment of the head of the invention could, for example, be made with a P2 pole piece 49 thickness of 1 to 3 microns and an approximately equal ZTH. The gap layer thickness is preferably about 0.25 to 0.33 times the width of the track. In addition, the head may be made with a physical P2 tip size under one micron.

From the state shown in FIG. 10 only prior art structures which are not shown, such as vias connecting coil1 37 and coil2 57, leads and protective material, are needed to complete the write head 23. As in prior art heads having two or more coils, the coils 37, 57 are electrically connected in series to a single pair of external pads (not shown), so that electric current can be driven through both coils to induce a magnetic field in the ferromagnetic yoke structure.

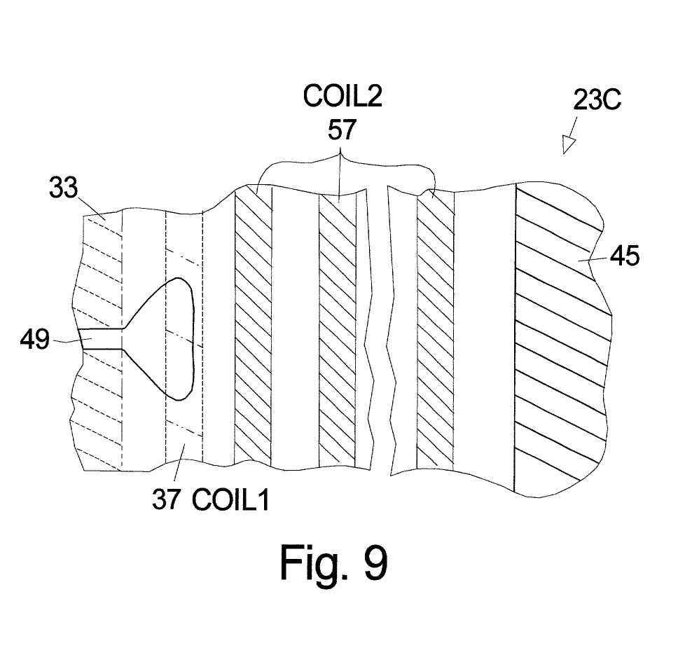

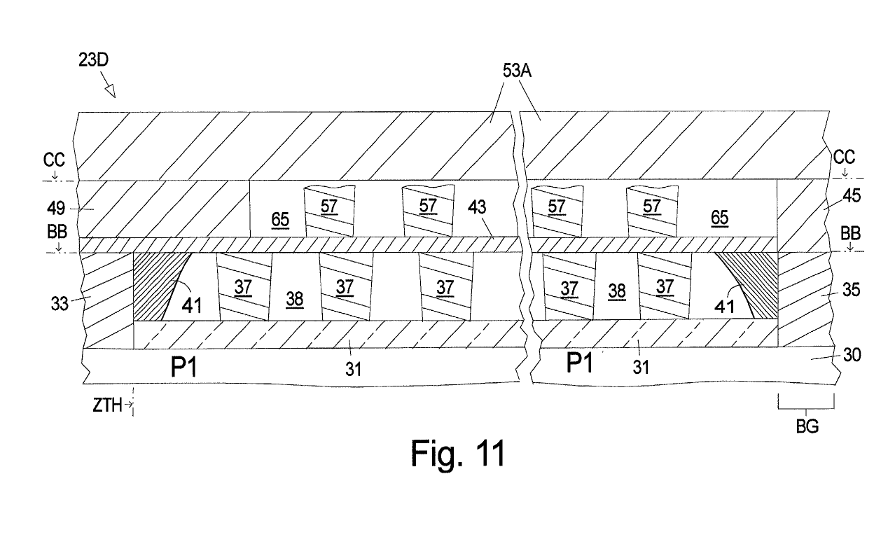

An alternative embodiment of a write head 23D according to the invention is illustrated in FIG. 11. Two independent, optional modifications from transducer 23C are shown. The method of fabricating write head 23D uses an additional planarization step after the permanent protective layer 65 is formed on the second coil 57. The selected planarization line is shown as line CC. This alternative planarizes the tops of the P2 pole piece 49 and upper back flux closure 45, as well as, planarizing the permanent protective layer 65, so that the P3 53A can be fully planar. In this case, however, the tops of the turns of coil2 57 cannot be exposed, since this would cause the turns of coil2 57 to be shorted out. The shape of the P2 pole piece 49 in plan view can be that shown in FIG. 9. In yet another alternative the P3 53A can also be laminated. A second optional modification illustrated in FIG. 11 extends the P3 53A out to what will become the ABS. The option of extending P3 53A to the ABS may be used without planarizing along line CC.

Thus far the structures have been described in section view. To show the relative widths of the key structures, FIG. 9 is a plan view showing the P2 pole piece 49, the P1 pedestal 33, coil2 57 and the upper back flux closure 45. Coil1 37 is shown in phantom, since it is below the surface at this stage. The ABS will be along the left side of this view as in the previous figures. This view shows that the P1 pedestal 33 is preferably wider than the tip of the P2 pole piece 49, for example, 10 or more times wider. This allows the P1 pedestal 33 to be trimmed or notched to match the tip of the P2 pole piece 49 by ion milling as is performed in the prior art. The P1 pedestal 33 also provides the domain control which is fully described in pending U.S. patent application bearing Ser. No. 09/154,527 which is commonly assigned with the present application. The P2 pole piece 49 in a plan view is preferably shaped with a narrow “neck” extending over the top of the P1 pedestal 33. As the P2 pole piece 49 extends back toward the coil2 57, it widens out to provide a stitch area on which P3 53 (not shown) can more easily be deposited. Subject to the constraints of the P3 53 stitching requirements, the length of the P2 49 is kept relatively short because it is important for the second coil 57 to be close to the ABS. The top of the upper back flux closure 45 is preferably larger in area than tip of the P2 pole piece 49.

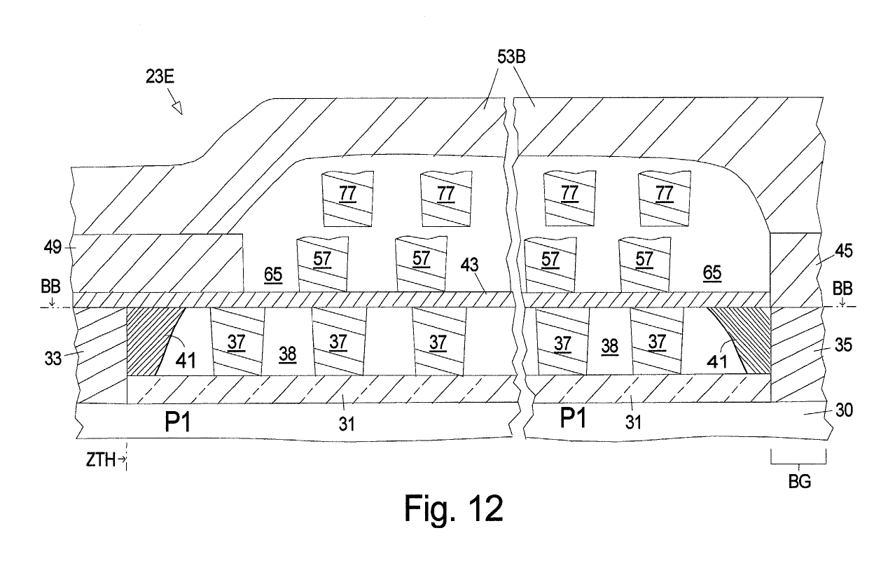

FIG. 12 illustrates a completed write head 23E according to an alternative embodiment of the invention. In the write head 23E, a third coil (coil3 77), has been formed on top of coil2 57 separated by protective material 65. Both coil2 57 and coil3 77 are covered by the arching P3 53B which is shown extending to the ABS, but alternatively may be stopped short of the ABS as noted previously.

Second Method of Fabricating a Write Head According to the Invention

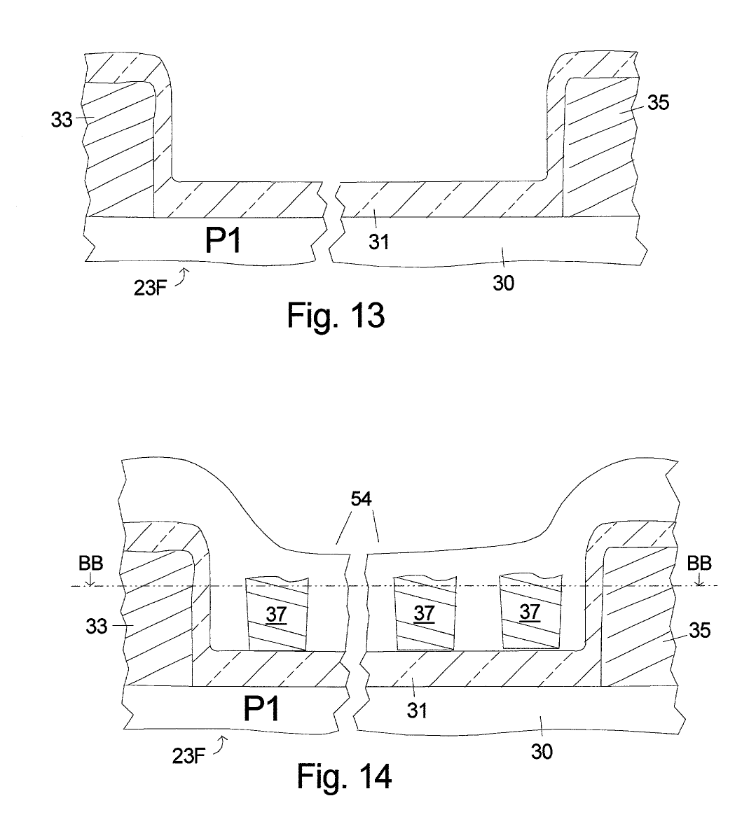

A second method of fabricating a write head 23F according to the invention will be described. Reference is made to FIG. 13 which shows that P1 pedestal 33 and lower back flux closure 35 have been formed on the planar surface of P1 30. A dielectric layer 31, preferably alumina, has been deposited to provide an insulated base on which to fabricate the first coil (not shown). Note that this method forms the P1 pedestal 33 and the lower back flux closure 35 before the first coil in contrast to the first method described above. FIG. 14 shows write 23F after the first coil 37 has been formed on top of the dielectric layer 31. The first coil 37 is formed using prior art techniques. A dielectric layer 54, such as thick alumina, is preferably deposited over wafer to protect the first coil 37 and to aid in planarization down to the line BB. The planarization process must continue until sufficient material has been removed so that the P1 pedestal 33 and lower back flux closure 35 are exposed and planarized. The tops of the turns of the first coil 37 may optionally be exposed. After the planarization step the process continues as in the first embodiment described above.

Third Method of Fabricating a Write Head According to the Invention

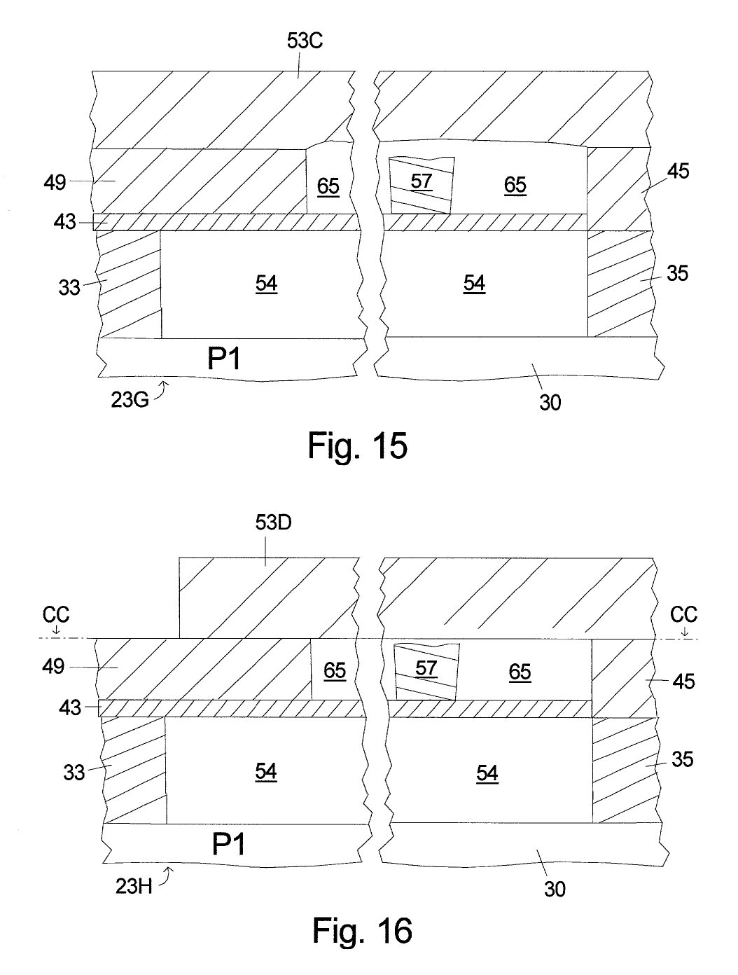

A third method of fabricating a write head 23G according to the invention will be described. Reference is made to FIG. 15 which shows that P1 pedestal 33 and lower back flux closure 35 have been formed on the planar surface of P1 30 as before. In this embodiment there is no coil below the gap layer 43 and, therefore, all of the fabrication steps relating to the formation of the first coil in the previous methods are omitted. The dielectric layer 54, preferably alumina, is deposited to fill the wafer to aid in planarization down to the line BB. After the planarization step the process continues as in the first method embodiment described above. The previously described optional modifications can be applied as well. For example, the P3 53C may extend to the ABS as is shown in FIG. 15. FIG. 16 illustrates other alternatives by showing that the P3 53D may be planarized and may be stopped short of the ABS. Although not shown, an additional coil may be placed above the coil 57 as has been previously described.

Other variations and embodiments according to the invention will be apparent to those skilled in the art which will nevertheless be with the spirit and scope of the invention.

What is claimed is:

1. A magnetic transducer comprising:
a gap layer extending from a write gap toward a back of a yoke, the gap layer being in contact with and conforming to a first planarized surface;
a first pole piece of ferromagnetic material having a second planarized surface;
a second pole piece with a tip positioned at the write gap and in contact with the gap layer;
a third pole piece of ferromagnetic material contacting the second pole piece and extending toward the back of the yoke;
a pedestal of ferromagnetic material extending from the planarized surface of the first pole piece to the write gap, a planarized surface of the pedestal being in contact with the gap layer, a back surface of the pedestal defining a zero throat height line and the back surface being perpendicular to a bottom surface of the second pole piece;
a first back flux closure of ferromagnetic material in contact with the first pole piece and forming part of the back of the yoke;
a second back flux closure of ferromagnetic material forming part of the back of the yoke in contact with the first back flux closure and extending to contact the third pole piece; and
a first coil including a plurality of turns of electrically conducting material which pass between the second pole piece, the third pole piece, the gap layer and the second back flux closure.

2. The magnetic transducer of claim 1 further comprising a second coil including a plurality of turns of electrically conducting material which pass between the first pole piece, the pedestal, the gap layer and the first back flux closure, the second coil being separated from the first pole piece by a layer of dielectric material disposed on the planarized surface of the first pole piece;

3. The magnetic transducer of claim 2, wherein the turns of the first coil have an average spacing distance and the back surface of the pedestal is located within the average spacing distance from the second coil.

4. The magnetic transducer of claim 2, wherein the turns of the first coil are in contact with the gap layer.

5. The magnetic transducer of claim 2, wherein the second coil has a surface that is part of the first planarized surface.

6. The magnetic transducer of claim 1, wherein the second pole piece has a narrowest extent over the pedestal and flares out to a wider extent further away from the pedestal.

7. The magnetic transducer of claim 6, wherein the third pole piece contacts the second pole piece at the wider extent and ends before an air bearing surface of the magnetic transducer.

8. The magnetic transducer of claim 6, wherein the third pole piece contacts the second pole piece at the wider extent and at the tip and extends to an air bearing surface of the magnetic transducer.

9. The magnetic transducer of claim 2, wherein the first planarized surface further includes an upper surface of the second coil, areas of photoresist and areas of alumina.

10. A magnetic transducer having a first pole piece (P1), a second pole piece (P2) and a third pole piece (P3) comprising:
a gap layer disposed on a first planarized surface;
a pedestal pole piece disposed in contact with a first side of the gap layer, the pedestal pole piece confronting the P2 across the gap layer forming a write gap, and the pedestal pole piece contacting the P1 which extends parallel to the gap layer to a back of a yoke;
the P3 being in contact with the P2 and extending to the back of the yoke;
ferromagnetic material forming the back of the yoke in contact with the P1 and the P3;
a first coil including a plurality of turns of electrically conducting material passing between the P1 and the gap layer; and
a second coil including a plurality of turns of electrically conducting material passing between the P3 and the gap layer and confronting the first coil, the first and second coils being separated by the gap layer.

11. The magnetic transducer of claim 10, wherein the first planarized surface further comprises an upper surface of the first coil.

12. The magnetic transducer of claim 11, wherein the first planarized surface further comprises areas of photoresist material and areas of alumina.

13. The magnetic transducer of claim 10, wherein the turns of the second coil are in contact with the gap layer.

14. The magnetic transducer of claim 10, wherein the first and second coils are in contact with the gap layer on opposite sides of the gap layer.

15. The magnetic transducer of claim 10, wherein the pedestal pole piece defines a zero throat height.

16. The magnetic transducer of claim 10, further comprising a third coil disposed between the second coil and the P3.

17. A method of fabricating a magnetic transducer on a wafer comprising the steps of:
depositing ferromagnetic material to form a first pole piece (P1) on the wafer;
a first planarizing step which removes material until a top surface of the first pole piece is planarized;
depositing a layer of dielectric material over the first pole piece;
forming a first coil, the first coil including a plurality of turns of conductive material disposed on the layer of dielectric material;
forming first and second vias through the layer of dielectric material to expose selected areas of the first pole piece, the first via being outside of the first coil and the second via being inside of the first coil;
forming a P1 pedestal of ferromagnetic material in the first via;
forming a lower back flux closure of ferromagnetic material in the second via;
a second planarizing step which removes material from a top surface of the wafer until a selected planarization line is reached where a top surface of the P1 pedestal and a top surface of the lower back flux closure are planarized;
depositing a gap layer of nonferromagnetic material on the wafer;
etching a third via through the gap layer to expose the top surface of the lower back flux closure;
forming an upper back flux closure of ferromagnetic material in the third via;
forming a second pole piece (P2) on the gap layer, the P2 extending over the P1 pedestal;
forming a second coil on the gap layer substantially confronting the first coil;
depositing insulating material over the second coil; and
forming a third pole piece (P3) of ferromagnetic material in contact with the P2 and the upper back flux closure.

18. The method of claim 17, further comprising the step of depositing alumina prior to the second planarizing step.

19. The method of claim 17, wherein the second planarizing step further comprises the step of removing material until a top surface of the first coil is exposed and planarized.

20. The method of claim 17, further comprising the step of forming a third coil before the step of forming the P3.

21. The method of claim 17 further comprising a third planarizing step which planarizes a top surface of the P2 and a top surface of the upper back flux closure prior to the step of forming the P3.

22. The method of claim 17, the step of forming the P2 further comprising forming the P2 with a narrowest extent over the P1 pedestal and flaring out to a wider extent to form a stitch area.

23. The method of claim 22, wherein the step of forming the P3 further comprises forming the P3 to contact the P2 on the narrowest extent and the wider extent.

24. A method of fabricating a magnetic transducer on a wafer comprising the steps of:
depositing ferromagnetic material to form a first pole piece (P1) on the wafer;
a first planarizing step which removes material from a top surface of the wafer until a top surface of the first pole piece is planarized;
forming a pedestal of ferromagnetic material on the first pole piece;
forming a lower back flux closure of ferromagnetic material on the first pole piece offset from the pedestal;
depositing a first layer of dielectric material on the wafer;
forming a first coil on the layer of dielectric material, the first coil having a plurality of turns of conductive material passing between the pedestal and the lower back flux closure;
depositing a second layer of dielectric material over the wafer to prepare for a second planarization;
a second planarizing step which removes material from a top surface of the wafer at least until a top surface of the pedestal and a top surface of the lower back flux closure are exposed and planarized;
depositing a gap layer on the wafer and in contact with the top surface of the pedestal;
etching a via through the gap layer to expose a top surface of the lower back flux closure;
forming an upper back flux closure of ferromagnetic material in the via;
forming a second pole piece (P2) on the gap layer, the P2 pole piece having a tip portion extending over the pedestal forming a write gap;
forming a second coil on the gap layer, the second coil having a plurality of turns of conductive material passing between the second pole piece (P2) and the upper back flux closure;
depositing insulating material over the second coil; and
forming a third pole piece (P3) of ferromagnetic material in contact with the second pole piece (P2) and the upper back flux closure to complete the yoke.

25. The method of claim 24, wherein the pedestal is formed with a back surface facing the first coil which is substantially perpendicular to the planarized surface of the first pole piece, the back surface defining a zero throat height.

26. The method of claim 24, wherein the step of depositing the second layer of dielectric material further comprises the step of vacuum depositing a layer of alumina.

27. The method of claim 24, the second planarizing step further comprising the step of removing material at least until a top surface of the first coil is exposed and planarized.

28. The method of claim 24 further comprising a third planarizing step which planarizes a top surface of the second pole piece (P2) and a top surface of the upper back flux closure prior to the step of forming the third pole piece (P3).

29. The method of claim 24, the step of forming a second pole piece (P2) further comprising forming the second pole piece P2 with a narrowest extent confronting the pedestal and flaring out to a wider extent toward the upper back flux closure.

30. The method of claim 29, wherein the third pole piece (P3) is formed in contact with the narrowest extent and the wider extent of the second pole piece.

31. A method of fabricating a magnetic transducer on a wafer comprising the steps of:
depositing ferromagnetic material to form a first pole piece (P1) on the wafer;
forming a pedestal of ferromagnetic material on the first pole piece;
forming a lower back flux closure of ferromagnetic material on the first pole piece offset from the pedestal;
depositing a layer of dielectric material over the wafer to prepare for a second planarization;
planarizing the wafer and removing material from a top surface of the wafer at least until a top surface of the pedestal and a top surface of the lower back flux closure are exposed and planarized;
depositing a gap layer on the wafer and in contact with the top surface of the pedestal;
etching a via through the gap layer to expose a top surface of the lower back flux closure;
forming an upper back flux closure of ferromagnetic material in the via;
forming a second pole piece (P2) on the gap layer, the P2 pole piece having a tip portion extending over the pedestal forming a write gap;
forming a coil on the gap layer, the coil having a plurality of turns of conductive material passing between the second pole piece (P2) and the upper back flux closure;
depositing insulating material over the coil; and
forming a third pole piece (P3) of ferromagnetic material in contact with the second pole piece (P2) and the upper back flux closure to complete the yoke.

32. The method of claim 31, wherein the pedestal is formed with a back surface substantially perpendicular to a plane of the gap layer, the back surface defining a zero throat height.

33. The method of claim 31, wherein the step of depositing the layer of dielectric material further comprises the step of vacuum depositing a layer of alumina.

34. The method of claim 31, the planarizing step further comprising the step of removing material at least until a top surface of the first coil is exposed and planarized.

35. The method of claim 31 further comprising a planarizing step which planarizes a top surface of the second pole piece (P2) and a top surface of the upper back flux closure prior to the step of forming the third pole piece (P3).

36. The method of claim 31, the step of forming a second pole piece (P2) further comprising forming the second pole piece P2 with a narrowest extent confronting the pedestal and flaring out to a wider extent toward the upper back flux closure.

37. The method of claim 31, wherein the third pole piece (P3) is formed in contact with the narrowest extent and the wider extent of the second pole piece.

38. A disk drive comprising:
a disk having a thin film of ferromagnetic material on a planar surface of the disk;
a spindle rotatably supporting the disk;
an actuator supporting a magnetic transducer having an air bearing surface confronting the planar surface of the disk; and
the magnetic transducer including a write head comprising:
a first pole piece (P1) having a planar surface;
a first coil including a plurality of turns of electrically conducting material substantially surrounded by electrically insulating material which insulates and separates the first coil from the first pole piece;
a pedestal pole piece on the planar surface of the first pole piece adjacent to and outside of the first coil;
a back flux closure structure extending from the first pole piece to form a back of a yoke;
a gap layer disposed on a first planarized surface including a top surface of the pedestal pole piece;
a second pole piece (P2) positioned with a tip area confronting the pedestal pole piece forming a write gap;
a second coil including a plurality of turns of electrically conducting material substantially surrounded by electrically insulating material, the second coil being adjacent to second pole piece (P2) and positioned to confront the first coil; and
a third pole piece (P3) in contact with the back flux closure structure and the second pole piece (P2) and extending over the second coil.

39. The disk drive of claim 38 wherein the second pole piece (P2) has a surface that is part of a second planarized surface in contact with the third pole piece (P3).

40. The disk drive of claim 38 wherein the pedestal pole piece has a width which is substantially wider than a width of the tip of the second pole piece (P2).

41. The disk drive of claim 38 wherein the second pole piece (P2) has a narrowest extent at the write gap and flares out to a widest extent forming a stitch area in contact with the third pole piece (P3).

42. The disk drive of claim 38 wherein the third pole piece (P3) contacts the second pole piece (P2) at the widest extent and the narrowest extent and extends to an air bearing surface of the magnetic transducer.
